(19) United States
(12) Patent Application Publication
(10) Pub. No.: US 2005/0036463 A1
(43) Pub. Date: Feb. 17, 2005

(54) Method and apparatus for efficient simultaneous re-activation of multiple dormant service instances in a CDMA2000 network

(75) Inventors: Sanket Satish Nesargi, Dallas, TX (US); Azeem Ahmad, Allen, TX (US); Mini Vasudevan, Plano, TX (US); Chung-Ching Wang, Plano, TX (US); Guy Helm, Plano, TX (US); Ke-Chi Jang, Plano, TX (US)

Correspondence Address: CARR LAW FIRM, L.L.P., 670 FOUNDERS SQUARE, 900 JACKSON STREET, DALLAS, TX, 75202, US

(73) Assignee: Nortel Networks Limited, St. Laurent (CA)

(21) Appl. No.: 10/917,569

(22) Filed: Aug. 13, 2004

Related U.S. Application Data
(60) Provisional application No. 60/495,283, filed on Aug. 15, 2003.

(51) Int. Cl. H04B 7/216

(52) U.S. Cl. 370/335

(57) ABSTRACT

The present invention provides for reactivating a plurality of dormant packet data services instances. A mobile station user desires to activate at least one dormant packet data service instance. A service negotiation is initiated between the mobile station data and the wireless support network supporting the mobile station; which includes sending from the mobile station to identify all of the dormant service instances desired to be activated.

### CROSS-REFERENCE TO RELATED APPLICATIONS

This application claims benefit of co-pending U.S. provisional patent application Ser. No. 60/495,283, filed Aug. 15, 2003, entitled “Method for Efficient Simultaneous Re-Activation of Multiple Dormant Service Instances,” which is hereby incorporated in its entirety, by reference.

### FIELD OF THE INVENTION

The present invention is generally directed to reactivating service instances and, more particularly, to the substantially simultaneous reactivation of a plurality of dormant service instances in a CDMA2000 network.

### BACKGROUND

CDMA2000 (Release A and above) Mobile Stations (MSs) support multiple Packet Data Service Instances (PDSIs). Each PDSI is uniquely identified by its Service Reference Identifier (SR_ID). A PDSI generally refers to a connection between a Mobile Station (MS) and the Radio Access Network (RAN). The connection is typically used to transport data packets between the two entities. A packet data session between the MS and the Packet Data Serving Node (PDSN) can have up to 6 PDSIs. During the lifetime of the packet data session, an instance of the point to point (PPP) protocol exists between a MS and the PDSN. The PDSN provides an interface between a packet-switched network and the radio access network.

At any given time a PDSI can be either in the active, dormant or null state. For each active PDSI, a Radio Link Protocol (RLP) instance exists between a Base Station (BS) and the MS over an air interface. Additionally, there is a bearer data connection over an A8 interface between the BS and a Packet Control Function (PCF). There is also a bearer data connection over the A10 interface between the PCF and the PDSN. For each PDSI, the bearer data connections are established using messages over signaling interfaces in the Radio Access Network (RAN) viz., the A9 interface between the BS and PCF and the A11 interface between the PCF and the PDSN.

When the PDSI is in the dormant state, the physical traffic channel resource for that PDSI is torn down. The air interface RLP instance between the base station and the mobile and the A8 connection between the base station and the PCF are also released. However, the A10 connection for a dormant PDSI between the PCF and the PDSN is maintained. A PPP connection between the MS and the PDSN persists as long as the packet data session between them contains at least one PDSI in the active or in the dormant state.

In the null state for a PDSI, all of the connections, through the employment of A8, A10, and the air interface RLP connection for that PDSI are torn down. When all of the PDSIs in a packet data session transition to the null state, the PPP connection between the MS and the PDSN is also torn down, and the packet data sessions transitions to null.

With a given MS, there can be a plurality of service instances set up, that is, non-null states, based on the nature of packet data traffic being transferred across them, and each one of these can either be in an active or dormant state. The Service Option (SO) associated with a service instance identifies the nature of packet data transferred over it, for example, real-time data such as multimedia data is sent over PDSIs with a service option of either 60 or 61.

In conventional technologies, a CDMA2000 Release “C” compliant MS can specify only one SR_ID, that is, the SR_ID corresponding to the one dormant PDSI that it wishes to reactivate, in its origination and “enhanced origination” messages. Generally, origination messages are sent when no air-interface RLP session for any PDSI exists between the MS and the BS. Enhanced Origination messages are sent when the MS is already on the traffic channel, that is, an RLP instance exists between the MS and the BS for at least one active service instance. Thus, the MS typically generates a separate origination message for each dormant PDSI it wishes to re-activate.

When multiple service instances need to be re-activated simultaneously, the MS typically generates separate originations and performs over-the-air service negotiation for each one, individually, for each PDSI, which is an expensive operation. However, if the MS is to simultaneously re-activate all its dormant PDSIs, Release “C” compliant mobile stations allow an origination message to be sent with the SR_ID set to 7. However, there is no support defined by the network currently for such originations.

In conventional technologies, however, the Base Station does not have stored within it the information, such as Service information, associated with a SR_ID, when all the service instances are either in the dormant state or the null state. Therefore, when the MS wishes for a service instance in the dormant state to become active, unless at least one service instance is in the active state, information such as the SO of the SR_ID for the dormant service instances, is not available at the base station. The base station needs this information to negotiate the service with the MS. That is, this information has to be supplied from elsewhere in the network in the case wherein the BS has all-dormant service instances.

Release CDMA2000“D” compliant MSs can explicitly list the SR_IDs corresponding to the service instances they want to activate and their respective Service Options (SOs) in origination messages. Thus, in this case, even if all service instances exist in the dormant state, there is no necessity to retrieve information from the network.

The fast call setup feature has been proposed to support the ability to activate all dormant PDSIs simultaneously in Release “C” and Release “D” mobiles with no service negotiation. This ability to avoid service negotiation is based on utilizing the stored Service Configuration Records (SCRs). The SCR is stored both at the MS and in the Radio Access Network (RAN), and contains channel configuration information through employment of SR_IDs and their corresponding service options for the last set of active PDSIs. A synchronization identifier (SYNC_ID) is uniquely associated with each SCR, and used to identify it.

When a MS is to use fast call setup to re-activate a PDSI, it includes the SYNC_ID of the SCR which contains information about the PDSI and the SR_ID corresponding to the PDSI. When this message is received at the RAN, the locally stored SCR corresponding to the SYNC_ID is retrieved and the PDSI for the corresponding SR_ID is re-activated without any service negotiation, because all the needed channel configuration information is available, and does not need to be negotiated. In case the SR_ID value is set to ‘7’, all PDSIs in the SCR corresponding to the included SYNC_ID are re-activated.

However, there is a problem with this approach. The SCR only contains the information of the latest set of active SR_IDs. If one wishes to invoke a change from dormant to active a different set of SR_IDs, this cannot be done effectively due to the incompleteness of the information available in the SCR. Only one SYNC_ID can be stored for Release “C” MSs, and if the same does not correspond to the SCR containing all the dormant SR_IDs for the MS, the fast call setup approach fails.

Release “D” MSs do not completely solve this problem. Release D allows for the use of up to fours SCRs for each MS, each which could have its own subset of dormant SR_IDs. However, the use of multiple SCRs by Release D does not necessarily correspond to the set of SR_IDs the MS wishes to re-activate as the universe of possible combinations of active SR_IDs exceeds the useful indexing of SCRs.

In other words, in either Release “C” or Release “D”, a SCR may not contain information about all dormant PDSIs for a MS. SCRs contain information about only those PDSIs which were the last set employed or were actively using the traffic channel. Dormant PDSIs are not included in the SCR. Thus, re-activation using the SYNC_ID approach, with the SR_ID set to ‘7’ for Release “C” MS, would result in only those PDSIs being re-activated which were active when the SCR was updated. Using this approach, the PDSIs which were dormant when the SCR was updated would never get re-activated at the same time.

For example, in the case that PDSI with SR_ID ‘S1 ’ is the only active PDSI. The SCR now contains only SR_ID number S1 {S1} and, say, has a SYNC_ID 10. Subsequently, S1 goes dormant and a new session S2 is added. When the SCR is updated, it now contains only {S2}. A new SYNC_ID, for example, SYNC_ID 20 can be created for this SCR, or the previous one, namely., SYNC_ID 10 may be updated. When a MS now is to re-activate all dormant PDSIs, it expects both S1 and S2 to go active. However, when it initiates a fast-call setup based re-activation with a SYNC_ID 10, either only S2 goes active, in S2's information was updated in the SCR with SYNC_ID 10. Alternatively, only S1 goes active, if S2's information was stored in a new SCR with SYNC_ID 20. From this example, it is evident that the proposed approach cannot re-activate all dormant PDSIs simultaneously. Also, the set of PDSIs that gets re-activated is not deterministic, and this is not desirable. In other words, one cannot deterministically predict the subset of service instances that gets reactivated for a given SYNC_ID.

Furthermore, it is not mandatory for Release C MSs to store the SYNC_ID. When this support is available, it is limited to one SYNC_ID per MS. Thus, the MS would be able to retain information regarding only the last SYNC_ID it received and re-activate dormant calls based on it. This limited SYNC_ID support further diminishes the effectiveness of the fast call setup based approach.

SYNC_ID support is mandatory for Release D MSs, and they are required to maintain up to 4 SYNC_IDs. However, origination messages can accommodate only one SYNC_ID and only service instance corresponding to the SCR associated with it can be re-activated simultaneously. Also, as is seen in the example above, typically no single SYNC_ID can include information about all dormant PDSIs. Hence, the SYNC_ID based approach does not guarantee simultaneous re-activation of all dormant PDSIs for either Release C or Release D MSs.

Therefore, there is need for a method to be able to re-activate multiple dormant service instances simultaneously in a deterministic manner, without needing to perform a service negotiation procedure separately for each service instance.

### SUMMARY OF THE INVENTION

The present invention provides for reactivating a plurality of dormant packet data services instances. A base station receives an indicia of requesting activation of at least one dormant data service instance when a packet data session is in a selected state. A service negotiation is initiated between the mobile station and the wireless support network supporting the mobile station. This includes sending data from the mobile station to identify all of the dormant service instances desired to be activated.

### BRIEF DESCRIPTION OF THE DRAWINGS

For a more complete understanding of the present invention, and the advantages thereof, reference is now made to the following description taken in conjunction with the accompanying drawings, in which:

FIG. 1 illustrates a mobile communicating with a RAN to a PDSN for substantially simultaneously activating a plurality of service instances;

FIG. 2 illustrates a nodal analysis of the reactivation of all dormant PDSIs when a data session is active for a Release C MS;

FIG. 3 illustrates a nodal analysis of the reactivation of all dormant PDSIs when a data session is dormant for a Release C MS;

FIG. 4 illustrates a nodal analysis of the reactivation of all dormant PDSIs when a data session is dormant for Release D MS;

FIG. 5A illustrates a base station configured to be used with an aggregated call reactivation for the simultaneous reactivation of service instances; and

FIG. 5B illustrates a packet control function configured to be used with an aggregated call reactivation for the simultaneous reactivation of service instances.

### DETAILED DESCRIPTION

In the following discussion, numerous specific details are set forth to provide a thorough understanding of the present invention. However, it will be understood by those skilled in the art that the present invention can be practiced by those skilled in the art following review of this description. Well-known elements have been illustrated in schematic or block diagram form in order not to obscure the present invention in unnecessary detail. Additionally, for the most part, details concerning CDMA systems and the like have been omitted inasmuch as such details are not considered necessary to obtain a complete understanding of the present invention, and are considered to be within the skills of persons of ordinary skill in the relevant art.

It is further noted that, unless indicated otherwise, all functions described herein are performed by a processor such as a computer or electronic data processor in accordance with code such as computer program code, software, and/or integrated circuits that are coded to perform such functions.

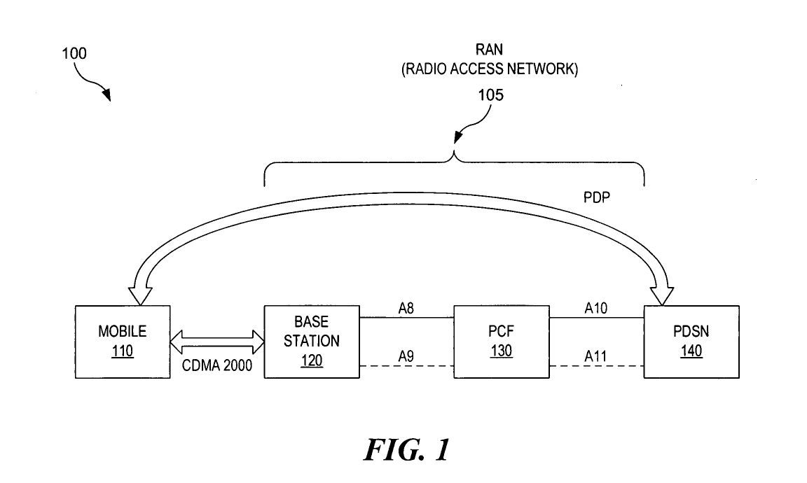

Turning now to FIG. 1, illustrated is a mobile communicating with a RAN to a PDSN for substantially simultaneously activating a plurality of service instances. Generally, the system 100 provides for three different approaches to allowing for the simultaneous re-activation of a plurality of service instances, each from a dormant state.

For Release “C”, state information of both the SR_ID and its corresponding service option is stored at a packet control function (PCF) 130 of FIG. 1. Each SR_ID corresponds to a PDSI. Generally, the PCF 130 provides a gateway between a packet data network and the MS 110, via the PDSN 140 and the RAN 105, which has the BS 120 and the PCF 130.

Generally, if all of the PDSIs are dormant, then the BS 120 does not keep any information about any dormant PDSIs. However, the PCF 130 is still in contact with the PDSN 140 over the A10 interface for the dormant PDSIs, and hence is aware of their existence. In release “C”, after receiving the SR_ID “7” in an origination or enhanced origination message indicating that all dormant sessions are to be made active, the BS 120 queries the PCF 130 over the A9 interface as to the identity of the SR_IDs of all the dormant service instances and their respective SOs. The PCF 130 then supplies the BS 120 these SR_IDs and the corresponding service options of these service instances over the A9 interface. Once the BS 120 has the SR_IDs and service options, the BS 120 then goes through a service negotiation with the MS to allocate the necessary resources, RLP connections and A8 connections, to re-activate all the dormant SR_IDs simultaneously through a single pair of A9 setup messages. This avoids having to negotiate between the MS 110 and the BS 120 individually for each SR_ID.

For Release “D”, the SR_IDs and the corresponding service options of all PDSIs that are selected to be activated simultaneously by the MS 110 typically are individually listed in an origination or enhanced origination message. These requests are received by the BS 120 which then sets up the various A8 connections through a single pair of A9 setup messages.

For both Release “C” and Release “D” MSs, information needed to setup multiple A8 and A10 connections is aggregated into a single A9 and A11 messages respectively. This eliminates the need to generate a separate A9/A11 message to re-activate each individual service instance at a time, resulting in substantial reduction in messaging overheads.

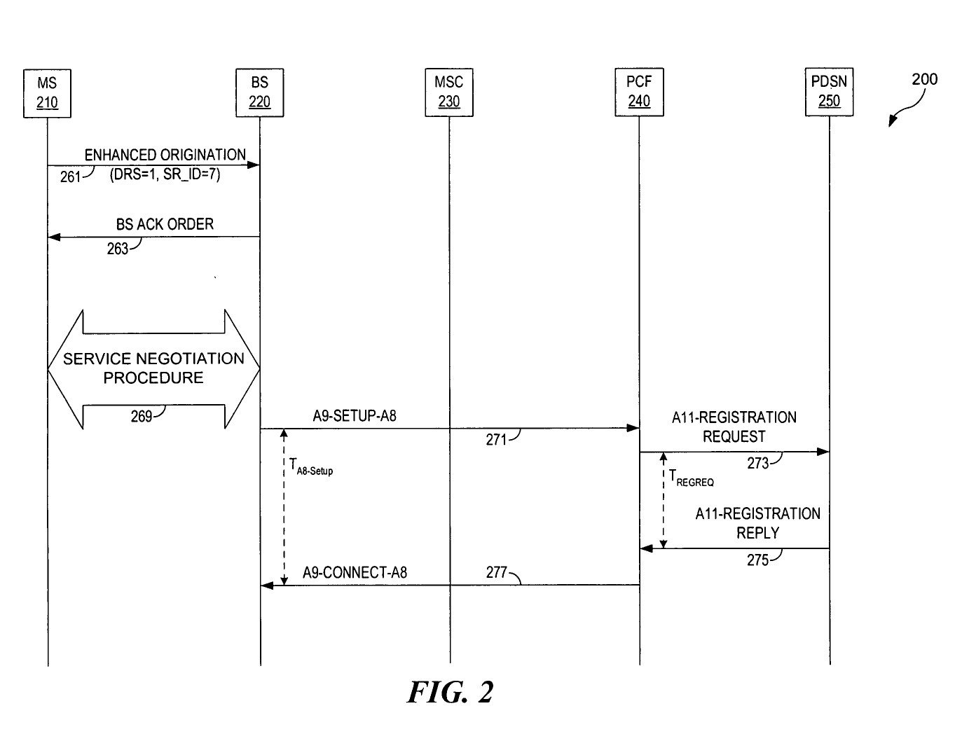

Turning now FIG. 2, a nodal flow diagram 200 for a Release “C” MS 210 is illustrated that requests simultaneous reactivation of all dormant PDSIs at this point in time. The packet data session is in an active state and a PPP connection exists between the MS 210 and the PDSN 250, and the BS 220 has all the necessary dormant service instance information to accomplish the simultaneous reactivation thereof. Generally, FIG. 2 illustrates a mechanism wherein A8 connections for all the dormant connections are set up through a single A9-Setup-A8 message containing aggregated information about all A8 connections that need to be established. Conventional standards require a separate A9 message to be sent for each A8 connection to be established.

In flow 261, the MS 210 sends an Enhanced Origination Message requesting the re-activation of all dormant PDSIs, indicated by SR_ID=7. Since the mobile has at least one active PDSI, there already exists a radio traffic channel established between the MS and the BS over the CDMA2000 air-interface. Hence, the MS 210 sends an enhanced origination message over the air. If no traffic channel existed, it would have sent an origination message over the air. In either case, the BS 220 should have all information necessary.

Optionally, in flow 263, the BS 220 acknowledges receipt of the Enhanced Origination message, thereby sending a Base Station Acknowledgement Order to the MS 210.

In flow 269, the BS and MS initiate service negotiation procedures for all PDSIs being re-activated substantially concurrently. Generally, signaling interfaces are needed to set up the data interfaces. RLP connections for each service instance being reactivated are established at this step.

In flow 271, the BS 210 sends out A9-Setup-A8 to the PCF 240 with the Data Ready to Send (DRS) indicator set to 1 to establish an A8 for each dormant PDSI (and starts the timer Tₐ₈₋ₛₑₜᵤₚ. This A9-Setup-A8 message includes the SR_ID and service option of every PDSI that needs to be re-activated. A separate A8 connection is needed for each PDSI. When transitioning a set of dormant PDSIs to active, a corresponding A8 connection needs to be set up for each PDSI being made active. In flow 273, the PCF 240 sends an A11-Registration Request message to the PDSN 250 with a non-zero lifetime setting and accounting data for each PDSI sent in flow 271.

In flow 275, the A11-Registration Request is validated for each SR_ID listed in the A11-Registration Request. The PDSN 250 sends an A11-Registration Reply message with an “accept” indication and the lifetime of the AI 0 connection set to a configured timer Tᵣₚ value for each validated SR_ID. Both PDSN 250 and PCF 240 create a binding record for each accepted A10 connection. The PCF 240 stops the timer T_{regreq}. Both PCF 240 and PDSN 250 start the timer for Tᵣₚ for validated PDSIs. This is a regular procedure in conventional CDMA standards to keep a lifetime for a A10 connection and tear it down, that is, release the data connection, such as the A10 connection, when the timer expires.

In flow 277, the PCF 240 establishes a bearer A8 connection and transmits an A9-Connect-A8 message listing all the SR_IDs for which an A8 connection has been successfully setup. The procedure is performed through a single message. However, multiple A8 connections are created as a result of it, and information pertaining to each created A8 is contained in a single message. The BS 220 stops the Tₐ₈₋ₛₑₜᵤₚ timer. The packet data session remains active and all previously dormant PDSIs are now active.

In conventional technologies, whereas earlier separate A9 messages were needed to set up individual A8 connections, in flow 200 now these connections can be set up through a single A9 message, potentially saving a few messages. Furthermore, in flow 269, service negotiation results in the establishment of multiple over-the-air RLP connections in a single round of message exchange. If conventional procedures were followed, each PDSI setup would require one round of service negotiation, resulting in multiple rounds of air-interface messaging, which has a highly negative performance impact, that is, wasted over-the-air messaging.

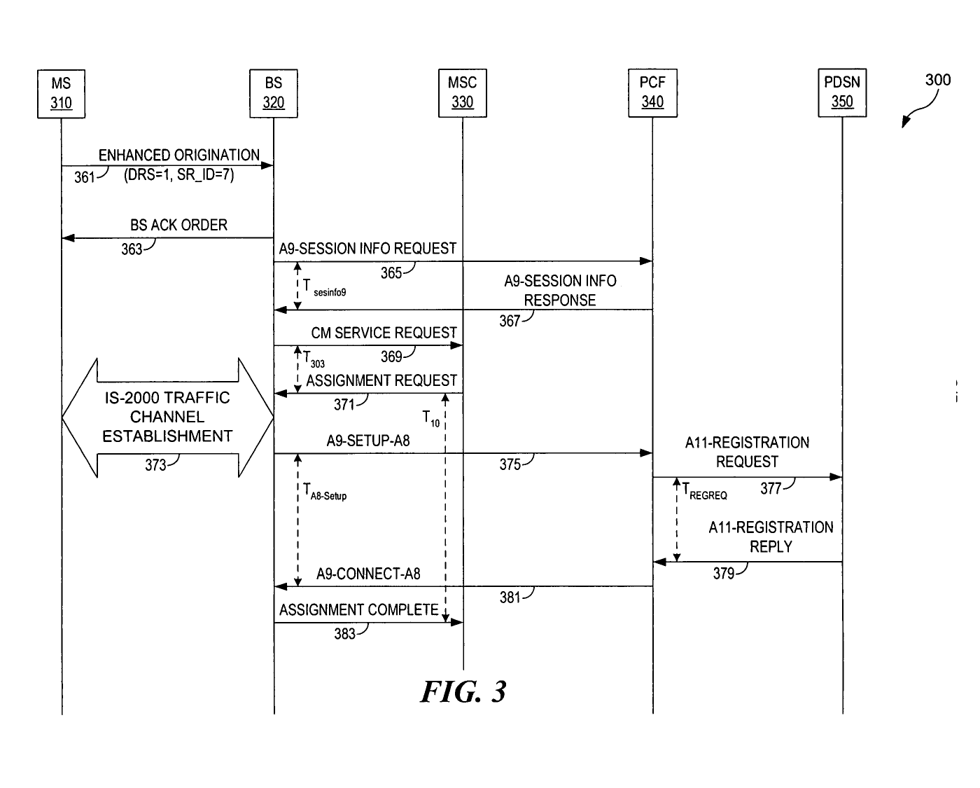

FIG. 3 is a flow diagram illustrating a packet data session is in a dormant state, with all data service instances currently dormant. In other words, the air interface between the mobile 110 and the BS 120 was torn down, as is the A8 interface. However, the PPP connection is still up and running, as are the A10 connections.

In flow 361, a MS 310 sends an Origination Message to a BS 320 having the SR_ID equal to 7 to request the re-activation of all dormant PDSIs. In this case the MS needs to send an Origination message, as no air-interface radio traffic channel exists between the MS and the PDSN.

In flow 363, as in conventional technology, the BS 320 acknowledges receipt of the Origination message by sending a Base Station Acknowledgement Order to the MS 310. In flow 365, the BS 320 sends an A9-Session Info Request message to the PCF 340, requesting the SR_IDs and SOs of all dormant PDSIs associated with the MS 310 generating the Origination. In flow 367, the PCF 340 responds with an A9-Session Info Response message containing the requested SR_IDs and their respective SOs.

In flow 369, the BS 320 constructs a connection management (CM) Service request message, places it in the OSI Complete Layer 3 Information message, sends message to the MSC 330 and starts the T₃₀₃ timer. This is a part of conventional procedures, that of when no air-interface connection exists between the MS 310 and the BS 320, and the MS 310 requests one via an Origination message. In the flow 300, a MSC 330 needs to be contacted to authorize the MS 310 and ensure that the MS 310 is actually authorized to allocate radio resources on the BS 320. Hence, the MSC 330 is involved in the call setup.

In flow 371, the MSC 330 sends an Assignment Request message to the BS 320 to request the assignment of radio resources and starts the timer T₁₀. A terrestrial circuit between the MSC 330 and the BS 320 is not setup for the packet data call. A terrestrial circuit is needed only for voice calls, not for packet data calls. Therefore, it is not allocated. The BS then stops the timer T₃₀₃.

In flow 373, the BS 320 and MS 330 initiate procedures to establish one RLP connection for each service instance to be reactivated. A single round of service negotiation is required to allocate radio resources for all the dormant calls identified in flow 367. In flow 375, the BS 320 sends out A9-Setup-A8 to the PCF 340, with the DRS indicator set to 1 to establish an A8 and starts the timer Tₐ₈₋ₛₑₜᵤₚ. This message lists each SR_ID returned in the A9-Session Info Response message and its corresponding service option.

In flow 377, the PCF 340 sends an A11-Registration Request message to the PDSN 350 with a non-zero lifetime setting and accounting data for each PDSI sent in flow 375. Accounting information is used for billing purposes to determine how much to charge the user non-zero lifetime setting means keeping the A10 connection up for its specified lifetime (non-zero) and tear it down subsequently, unless its lifetime lease is renewed. In flow 377, the A11-Registration Request is validated for each SR_ID listed in the A11-Registration Request. The PDSN 350 accepts sends an A11 Registration Reply message with an accept indication and the lifetime set to the configured Tᵣₚ value for each validated SR_ID. Both PDSN 350 and PCF 340 create a binding record for each accepted A10 connection. The PDSN 350 sends this information to the PCF 340 in flow 379. The PCF 340 then stops the timer T_{regreq}. Typically, both PCF 340 and PDSN 350 start the timer Tᵣₚ for validated PDSIs.

In flow 381, the PCF 340 establishes a bearer A8 connection and transmits an A9-Connect-A8 message, listing all the SR_IDs for which an A8 connection has been successfully setup. After reception, the BS stops the T_{A8-setup} timer. The BS 320 transmits the Assignment Complete message in flow 383 to the MSC 330. The MSC 330 stops the timer T₁₀. Alternatively, this step can occur at any time after the radio link establishment. The packet data session transitions to the Active state upon successful activation of the first PDSI. All previously dormant PDSIs are now active. The ability to retrieve information from the PCF is illustrated within the flow diagram 300.

Generally, the flow diagram 300 provides MSs 310 with the ability to simultaneously activate all dormant PDSIs. This results in a decrease of air-interface messaging. Since all PDSIs can now be re-activated with a single round of service negotiation 373, it also reduces the latency involved in re-activating all PDSIs. The set of PDSIs that are re-activated by the proposed invention is deterministic, unlike the previously proposed approaches.

There are at least two main differences between FIG. 2 and FIG. 3. In FIG. 2, an air-interface connection already exists between the MS and the BS, there is no need to contact the MSC. Also, in FIG. 2, the BS already has all information about dormant service instances and does not need to retrieve them from the PCF. However, in FIG. 3, it needs to do so, via the A9-Session-Info Request/Response pair of messages.

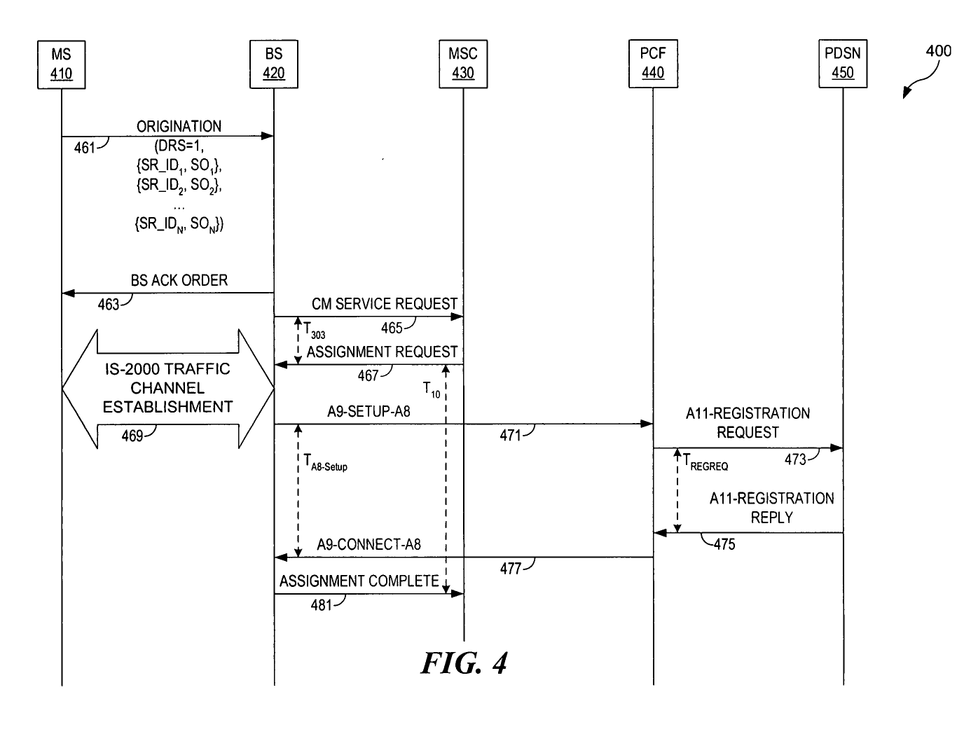

Turning now to FIG. 4, illustrated is a nodal analysis of the reactivation of all dormant PDSIs when a data session is dormant for type “D” mobile station. Generally, the nodal analysis diagram of FIG. 4 has some aspects in common with the nodal analysis diagram of FIG. 3. For instance, there is no air-interface connection existing between the MS and the BS, and hence the MSC is involved in setting up the connection. However, because all SR_ID and service options are already included in the origination message 461 in FIG. 4, the BS 420 does not need to go to the PCF 440 to retrieve dormant PDSI information. One such possibility is through the A9-Session Info Request/Response messages. Generally, in the flow nodal analysis 400, the packet data session has no active service instance, and therefore no air interface between MS and BS, no A8 between BS and PCF. PPP still exists between MS and PDSN. The MS 410 is a Release “D” mobile.

In flow 461, the MS 410 sends an Origination Message requesting the re-activation of dormant PDSIs explicitly listed along with their respective Service Options. In flow 463, the BS 420 acknowledges receipt of the Origination message by sending a Base Station Acknowledgement Order to the MS.

In flow 465, The BS constructs the CM Service Request message, places it in the OSI Complete Layer 3 Information message, sends a message to the MSC, and starts the T₃₀₃ timer. In flow 467, the MSC 430 sends an Assignment Request message to the BS to request the assignment of radio resources and starts the timer T₁₀. A terrestrial circuit between the MSC 430 and the BS 420 is not setup for the packet data call. The BS 420 stops the timer T₃₀₃.

In flow 469, the BS 420 and MS 410 initiate procedures to establish a radio channel. A single round of service negotiation is required to allocate radio resources for all the dormant calls identified in flow 461. In flow 469, an IS-2000 RLP connection is set up for each service instance being activated.

In flow 471, the BS 420 sends out A9-Setup-A8 to the PCF 440 with the DRS indicator set to 1 to establish an A8, starts the timer Tₐ₈₋ₛₑₜᵤₚ, and is used to ensure reliability. For instance, if a A9-Complete-A8 is not received before the timer A a8-setup expires, the A9-Setup-A8 message is sent again to the PCF. This message lists each SR_ID contained in the Origination message. In flow 473, the PCF 440 sends an A11-Registration Request message to the PDSN 450 with a non-zero lifetime setting and accounting data for each PDSI sent in flow 471. The A-11 Registration Request is validated for each SR_ID listed in the A11-Registration Request.

The PDSN 450 accepts an A11-Registration Reply message in flow 475 with and accept indication and the lifetime set to the configured Tᵣₚ value for each validated SR_ID. The improvement is the ability to send information in single A9 and A11 messages, as opposed to one for each A8/A10 connection. Both PDSN 450 and PCF 440 create a binding record for each accepted A10 connection. The PCF 440 stops the timer T_{regreq}. Both PCF 440 and PDSN 440 start the timer Tᵣₚ for validated PDSIs.

In flow 477, the PCF 440 establishes a bearer A8 connection for each re-activated service instance and transmits an A9-Connect-A8 message listing all the SR_IDs for which an A8 connection has been successfully setup. The BS 420 stops the Tₐ₈₋ₛₑₜᵤₚ timer.

In flow 481, the BS 420 transmits the Assignment Complete message to the MSC 430. The MSC 430 stops the timer T₁₀. This step can occur at any time after the radio link establishment. Generally, the packet data session transitions to the Active state upon successful activation of the first PDSI. All previously dormant PDSIs are now active.

FIG. 4 also enhances Inter-Operability Specification (IOS), the standard defining the interface between the BS and PCF, PCF and PDSN and BS and the MSC to support additional information available in Release D messages. These features can result in savings, as they lead to more efficient utilization of the air-interface. The reduction in number of messages on the control plane through the employment of the A9 and A11 interfaces to help reduce control message congestion at the PCF and PDSN. The reduced re-activation latency is an attribute visible to the end-user.

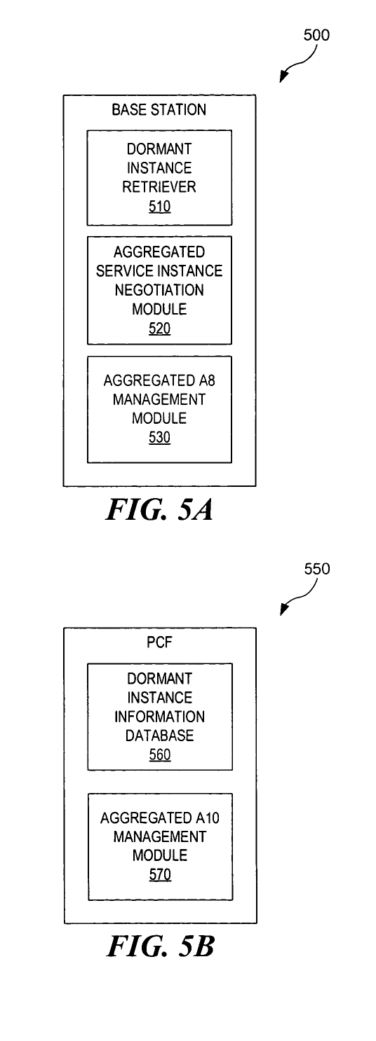

Turning now to FIG. 5A, illustrated is a base station 500 employable to aggregate a plurality of service instance identifiers. The BS 500 has a dormant instance retriever 510, an aggregated service instance negotiation module 520, and an aggregated A8 management module 530. The dormant instance receiver 510 is configured to retrieve indicia of dormant service instances from elsewhere in the network, such as from a packet control function. The aggregated service instance negotiation module 520 is employed to negotiate the air interface configuration for all service instances to be re-activated, between the BS 500 and a mobile. The aggregated A8 management module 530 manages the A8 interface between the BS 500 and a PCF via A9 messages that aggregate information about multiple service instances.

Turning now to FIG. 5B, illustrated is a packet control function 550 employable to respond to a request of an aggregate of a plurality of service instance identifiers. The PCF 550 has a dormant instance information database 560 and an aggregated A10 management module 570. The dormant instance database 560 stores indicia of dormant service instances. This information is provided on a per-request basis to the BS via A9 messages. The aggregated A10 management module 570 manages the A10 interface between the BS 500 and the PCF 550 using A11 messages that aggregate information about multiple service instances.

It is understood that the present invention can take many forms and embodiments. Accordingly, several variations can be made in the foregoing without departing from the spirit or the scope of the invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention can be employed without a corresponding use of the other features. Many such variations and modifications can be considered obvious and desirable by those skilled in the art based upon a review of the foregoing description of preferred embodiments. Accordingly, it is appropriate that the appended claims be construed broadly and in a manner consistent with the scope of the invention.

1. A method for reactivating a plurality of packet data services instances, comprising the steps of:
receiving, at a base station (BS), an indicia of requesting activation of at least one dormant packet data service instance when a packet data session is in a selected state; and
initiating a service negotiation between a mobile station and a wireless support network supporting the mobile station, which includes receiving data by the base station employable to identify all of the dormant service instances desired to be activated.

2. The method of claim 1, wherein the selected state further comprises an active state.

3. The method of claim 1, wherein selected state further comprises a dormant state.

4. The method of claim 1, further comprising a step of bearer path establishment between a base station and a packet control function (PCF).

5. The method of claim 4, wherein the step of bearer path establishment further comprises setting up of an aggregate of A8 connections between the Base Station and the PCF.

6. The method of claim 1, further comprising a step of connection set-up between a packet control function and a Packet Data Service Node (PDSN).

7. The method of claim 6, wherein the step of bearer path establishment further comprises setting up of an aggregate of A10 connections between the PCF and the PDSN.

8. A method for reactivating a plurality of dormant data service instance when the data session is active, comprising:
receiving an origination signal from a mobile station;
initiating an acknowledgment signal at a base station;
initiating a service negotiation procedure between the mobile station and the base station;
setting up an aggregation of a plurality of data links between the base station and the packet control function;
requesting a data link setup between the base station and a packet control function;
initiating a registration request from a packet control function to a packet data serving node;
aggregating the plurality of data links between the PCF and the PDSN;
accessing indicia of the registration request by the PDSN, wherein the indicia of the registration request comprises indicia of at least one SR_ID to be activated;
transmitting indicia of the registration request by the PDSN to the packet control function; and
coupling the packet control function and the base station through a data interface.

9. The method of claim 8, wherein the step of connecting the packet control function further comprises connecting through an A8 data interface.

10 The method of claim 8, wherein the at least one SR_ID further comprises a plurality of SR_IDs.

11. A method for reactivating a plurality of dormant data service instance when the data session is dormant, comprising:
receiving an origination signal from a mobile station;
initiating an acknowledgment signal at a base station;
requesting SR_ID indicia from the base station to a packet control station;
returning SR_ID indicia from the packet control function to the base station;
initiating a service negotiation procedure between the mobile station and the base station;
setting up an aggregation of a plurality of data links between the base station and the packet control function;
requesting a data link setup between the base station and a packet control function;
initiating a registration request from a packet control function to a packet data serving node;
aggregating the plurality of data links between the PCF and the PDSN;
accessing indicia of the registration request by the PDSN, wherein the indicia of the registration request comprises indicia of at least one SR_ID to be activated;
transmitting indicia of the registration request by the PDSN to the packet control function; and
coupling the packet control function and the base station through a data interface.

12. The method of claim 11, wherein the step of connecting the packet control function further comprises connecting through an A8 data interface.

13. The method of claim 11, wherein the at least one SR_ID further comprises a plurality of SR_IDs.

14. The method of claim 1 further comprising sending a service request from the base station to the mobile station controller.

15. The method of claim 14, further comprising responding to the service request from the mobile station controller to the base station.

16. A method for reactivating a plurality of dormant data service instance reactivation of all dormant PDSIs when a data session is dormant for type “D” mobile station, comprising:
receiving an origination signal from a mobile station;
initiating an acknowledgment signal at a base station to the mobile station;
setting up an aggregation of a plurality of data links between the base station and the packet control function;
requesting SR_ID indicia from the base station to a packet control station;
returning SR_ID indicia from the packet control function to the base station;
sending a service request from the base station to the mobile station controller
responding to the service request from the mobile station controller to the base station.
initiating a service negotiation procedure between the mobile station and the base station;
requesting a data link setup between the base station and a packet control function;
initiating a registration request from a packet control function to a packet data serving node;
aggregating the plurality of data links between the PCF and the PDSN;
accessing indicia of the registration request by the PDSN, wherein the indicia of the registration request comprises indicia of at least one SR_ID to be activated;
transmitting indicia of the registration request by the PDSN to the packet control function; and
coupling the packet control function and the base station through a data interface.

17. The method of claim 16, wherein the step of connecting the packet control function further comprises connecting through an A8 data interface.

18. The method of claim 16, wherein the at least one SR_ID further comprises a plurality of SR_IDs.

19. A system for substantially simultaneously reactivating a plurality of dormant service instances, comprising:
a base station configured to send a data link setup request, the data link setup signal employable to indicate a plurality of service instances;
a packet control function configured to receive the data link setup request; and
a packet data control network configured to receive indicia of the data link setup signal request.

20. The system of claim 19, wherein the PCF has stored within indicia of a plurality of dormant service instances.

21. The system of claim 19, wherein the data link comprises an A8 data link.

22. The system of claim 19, wherein the base station is further configured to send an A9 session info request.

23. The system of claim 22, wherein the PCF is further configured to send an A9 session info response.

24. A base station, comprising:
a receiver for receiving indicia of an aggregation of service instances from a
a receiver to receive indicia of an aggregation of dormant service instances from a second apparatus;
a connector to establish bearer connections with a second apparatus; and
a negotiator to negotiate aggregated service with the first apparatus.

25. The base station of claim 24, wherein the first apparatus comprises a packet control function.

26. The base station of claim 24, wherein the second apparatus comprises a mobile station.

27. A packet control function,
a provider for providing indicia of an aggregation of dormant service instances; and
a connector to set up an aggregation of service instances with a packet data serving node.
